(19) United States
(12) Patent Application Publication
(10) Pub. No.: US 2014/0225300 A1
(43) Pub. Date: Aug. 14, 2014

(54) POWDER MOLDING DEVICE AND PRODUCTION METHOD FOR POWDER MOLDED PRODUCT

(71) Applicants: Yuji Shibata, Kawasaki-shi (JP); Kazuyuki Onishi, Kawasaki-shi (JP)

(72) Inventors: Yuji Shibata, Kawasaki-shi (JP); Kazuyuki Onishi, Kawasaki-shi (JP)

(73) Assignee: ZEON CORPORATION, Tokyo (JP)

(21) Appl. No.: 14/241,500

(22) PCT Filed: Aug. 29, 2012
(86) PCT No.: PCT/JP2012/071878

§ 371 Date: Feb. 27, 2014

(30) Foreign Application Priority Data
Aug. 31, 2011 (JP) 2011-188831

(51) Int. Cl. B29C 43/28; B29C 43/26; B29C 43/46; B29C 43/24

(52) U.S. Cl. CPC B29C 43/28; B29C 43/24; B29C 43/265; B29C 43/46; B29C 2043/467
USPC 264/171.13; 425/335; 425/505; 264/175

(57) ABSTRACT

A powder molding device, including: a pre-molding unit (6) for molding a sheet-form powder (14) having a first density higher than a density of the powder and not having fluidity by compressing a powder; and a molding roll (8) for molding a sheet-form molded product (16) having a second density higher than the first density by compressing the sheet-form powder.

### TECHNICAL FIELD

The present invention relates to a powder molding device producing a sheet-form molded product by compression-molding a powder that contains an electrode active material and the like, and relates to a method of producing a powder molded product.

### BACKGROUND ART

The demand for electrochemical devices such as a lithium ion secondary battery and an electric double-layered capacitor, which are small, lightweight, high in energy density and repeatedly chargeable/dischargeable, is expected to expand in the future also from the viewpoint of environmental friendliness. The lithium-ion secondary battery is high in energy density and in use in fields such as mobile phones and notebook personal computers, while the electric double-layered capacitor is quickly chargeable/dischargeable and in use as a memory-backup small power source of a personal computer and the like. Further, a lithium-ion capacitor, which uses a redox reaction (pseudo electricity double-layer capacitance) on the surface of a metal oxide or a conductive polymer, also attracts attention due to the size of its capacitance. With expansion and development of applications of these electrochemical devices, more improvement is required for their performance such as lower resistance and higher capacitance. Among these, realization of the lower resistance requires production of a thin electrode.

Such an electrochemical device electrode can be obtained as an electrode sheet, and for example, compression molding of a powder is performed for producing a sheet-form molded product such as the electrode sheet from a powder that contains an electrode active material. For example, Patent Document 1 discloses a method of producing a laminate 22 of a sheet-form molded product 16 and the backup substrate 18 by causing a powder 12 such as a composite particle and a backup substrate 18 such as a current collector to simultaneously pass through the molding rolls 40 using a roll type pressure-molding device 38 having molding rolls 40 made up of a pair of rolls 40A, 40B, as shown in FIG. 7. Further, Patent Document 2 discloses a technique for reducing film thickness of a sheet-form molded product by providing a preliminary depression roll for preliminarily depressing a powder between this roll and one of a pair of rolls.

### CITATION LIST

### Patent Literature

Patent Document 1: JP 2006-303395 A
Patent Document 2: JP 2002-212608 A

### SUMMARY OF INVENTION

### Technical Problem

However, among sheet-form molded products, each obtained by the method of a sheet-form molded product according to Patent Document 1 and having no-defect surface, the thinnest one had a thickness (film thickness) of about 200 to 300 μm. That is, when a sheet-form molded product with a film thickness of 100 μm or less is produced by use of the foregoing method of molding a sheet-form molded product, a defect may occur on the surface of the sheet-form product, for example, the thickness of the sheet-form product becomes uneven due to aggregation of the powder.

Further, in the method of molding a sheet-form molded product according to Patent Document 2, the powder is just placed on the rolling roll by the preliminary depression roll, and hence the powder might be fluidized until it is compressed by the rolling roll. This causes a defect on the surface of the sheet-form molded product, for example, the thickness becomes uneven.

An object of the present invention is to provide a powder molding device and a method of producing a powder molded product, which are capable of producing a sheet-form molded product with a no-defect surface and a smaller film thickness.

### Solution to Problem

In order to solve the above problem, the present inventors repeated extensive researches, and found that a sheet-form molded product having fewer defects and a smaller film thickness can be obtained by pre-molding a powder in a first step so as to uniformly spread the powder without fluidization/aggregation thereof, and by performing regular compression in a second step.

The present invention was completed based on these findings.

Therefore, according to the present invention, the following are provided.

(1) A powder molding device including: a pre-molding unit for molding a sheet-form powder having a first density higher than a density of the powder by compressing a powder and the sheet-form power not having fluidity; and a molding roll for molding a sheet-form molded product having a second density higher than the first density by compressing the sheet-form powder.

(2) The powder molding device according to (1), wherein the first density is not lower than 130% and not higher than 300% of the density of the powder.

(3) The powder molding device according to (1) or (2), wherein the pre-molding unit is provided with a pre-molding roll having a smaller diameter than a diameter of the molding roll.

(4) The powder molding device according to (3), wherein the diameter of the pre-molding roll is not smaller than 10 mm and not larger than 500 mm.

(5) The powder molding device according to any one of (1) to (4), wherein the pre-molding unit molds a pre-laminate including the sheet-form powder and the backup substrate by compressing the powder onto a backup substrate, and the molding roll molds a laminate including the sheet-form molded product and the backup substrate by compressing the pre-laminate.

(6) A method of producing a powder molded product including a pre-molding step of molding a sheet-form powder having a first density higher than a density of the powder and not having fluidity by compressing a powder; and a regular compression step of molding a sheet-form molded product having a second density higher than the first density by compressing the sheet-form powder by use of a pair of molding rolls.

(7) The method of producing a powder molded product according to (6), wherein the first density is not lower than 130% and not higher than 300% of the density of the powder.

(8) The method of producing a powder molded product according to (6) or (7), wherein in the pre-molding step, the powder is compressed by use of a pre-molding roll having a smaller diameter than a diameter of the molding roll.

(9) The method of producing a powder molded product according to (8), wherein the diameter of the pre-molding roll is not smaller than 10 mm and not larger than 500 mm.

(10) The method of producing a powder molded product according to any one of (6) to (9), wherein, in the pre-molding step, the powder is compressed onto a backup substrate to mold a pre-laminate including the sheet-form powder and the backup substrate, and in the regular compression step, the pre-laminate is compressed by use of the molding rolls to mold a laminate including the sheet-form molded product and the backup substrate.

### Advantageous Effects of Invention

According to a powder molding device and a method of producing a powder molded product in the present invention, it is possible to produce a sheet-form molded product with a no-defect surface and a smaller film thickness.

### BRIEF DESCRIPTION OF DRAWINGS

FIG. 1 is a view showing an outline of a powder molding device according to an embodiment of the present invention.

FIG. 2 is a view showing a pre-molding unit according to another embodiment of the present invention.

FIG. 3 is a view showing a pre-molding unit according to another embodiment of the present invention.

FIG. 4 is a view showing a pre-molding unit according to another embodiment of the present invention.

FIG. 5 is a view showing a pre-molding unit according to another embodiment of the present invention.

FIG. 6 is a view showing a pre-molding unit according to another embodiment of the present invention.

FIG. 7 is a view showing an outline of a conventional powder molding device.

### DESCRIPTION OF EMBODIMENTS

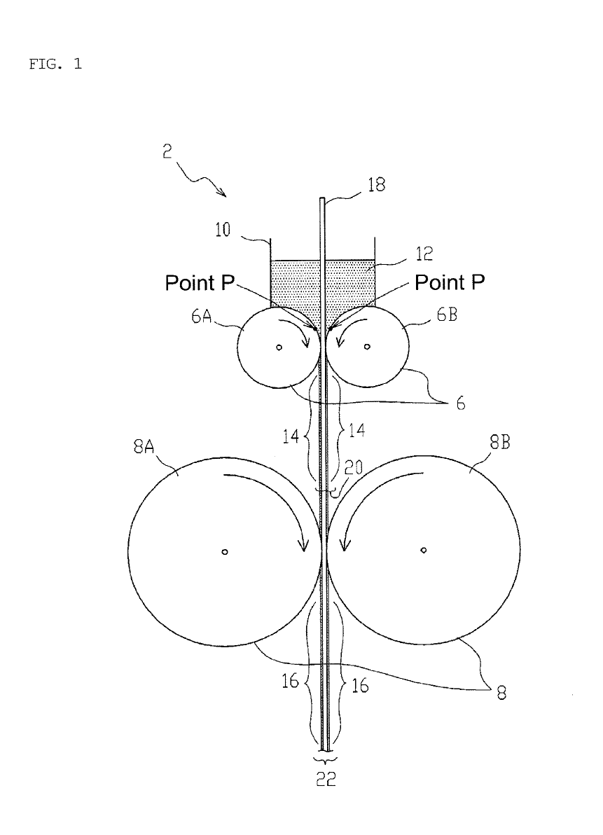

Hereinafter, a powder molding device and a method of producing a powder molded product according to embodiments of the present invention will be described with reference to the drawings. FIG. 1 is a view showing an outline of a powder molding device according to an embodiment. A powder molding device 2 is provided with: pre-molding rolls 6 including a pair of rolls 6A, 6B which are arrayed horizontally and in parallel; and molding rolls 8 including a pair of rolls 8A, 8B which are arrayed horizontally and in parallel below the pre-molding roll 6, and a powder 12 is stored in a space formed above the pre-molding rolls 6 by the pre-molding rolls 6 and a partition plate 10.

The rolls 6A, 6B of the pre-molding rolls 6 respectively rotate in directions of arrows shown in FIG. 1 to bite the powder 12, and preliminarily compress the powder 12 onto both sides or one side of the backup substrate 18. There is thus molded a sheet-form powder 14 where the powder 12 is preliminarily compressed onto both sides or one side of the backup substrate 18 having passed through the rolls 6A, 6B, and the powder 12 does not have fluidity. Here, in the pre-molding rolls 6, the compression is preferably performed such that a density of the sheet-form powder 14 is from 130% to 300% of a density of the powder 12, and the compression is further preferably performed such that the density of the sheet-form powder 14 is on the order of 150% of the density of the powder 12. For example, when the powder 12 with a loose bulk density of 0.45 g/cc is compressed by the pre-molding rolls 6, the density of the sheet-form powder 14 is 0.75 g/cc. Further, when this sheet-form powder 14 is compressed by molding rolls 8 described later, a sheet-form molded product 16 with a density of 1.5 g/cc is obtained.

Although the respective rolls 6A, 6B of the pre-molding rolls 6 rotate by being driven by motors or the like, respective rotating speeds of the rolls 6A, 6B are freely changeable. That is, the respective rolls 6A, 6B may be rotated in the opposite directions at the same speed, or may be rotated in the opposite directions at different speeds. When rotated at different speeds, preliminarily compression can be performed on the powder 12 while applying shearing force thereto.

Further, the pre-molding roll 6 is provided with a temperature adjustment mechanism capable of adjusting a temperature for cooling, heating and the like in accordance with the kind and properties (physical properties, chemical properties, etc.) of the powder. Examples of the temperature adjustment mechanism may include a method of using a heating medium arranged inside each of the rolls 6A, 6B and a method of direct heating by a heating wire or the like.

It is to be noted that the peripheries of the rolls 6A, 6B of the pre-molding rolls 6 may be provided with engraving such as concave and convex shapes for controlling a bitten amount of the powder 12. In this case, a surface roughness of the sheet-form powder 14 can be changed, and a thickness of the sheet-form molded product 16 obtained after passing through the molding rolls 8 can be changed. For example, when the periphery is partially provided with engraving in a diagonal shape, the amount of the powder 12 bitten into the pre-molding rolls 6 increases or decreases, and hence thereby to allow a change in thickness of the sheet-form molded product 16 in a parallel direction to the rolls 6A, 6B of the pre-molding rolls 6 for the sheet-form powder 14, namely in a moving direction of the backup substrate 18. It is thus possible to change the thickness in the vertical direction (in FIG. 1) of the sheet-form molded product 16 obtained after passing through the molding rolls 8.

The molding rolls 8 rotate in directions of arrows shown in FIG. 1, to compress the sheet-form powder 14. The sheet-form molded product 16 is obtained by compressing the sheet-form powder 14. Here, the respective rolls 8A, 8B of the molding rolls 8 rotate by being driven by motors or the like, but respective rotating speeds of the rolls 8A, 8B are freely changeable, as are the foregoing rolls 6A, 6B of the pre-molding rolls 6. Further, the molding roll 8 is provided with a temperature adjustment mechanism, as is the pre-molding roll 6.

It is to be noted that the peripheries of the rolls 8A, 8B of the molding rolls 8 may be provided with engraving such as concave and convex shapes. By providing the engraving, a pattern is formed on the surface of the sheet-form molded product 16, to allow a change in roughness of the sheet surface. Further, when the peripheries of the rolls 8A, 8B are partially provided with engraving in a linear shape, lines drawn onto the rolls 8A, 8B can be transferred onto the sheet-form molded product 16.

Next, a procedure for producing the sheet-form molded product by the powder molding device 2 will be described. The powder 12 stored in a space formed by the pre-molding rolls 6 and the partition plate 10 is bitten into the pre-molding rolls 6 and preliminarily compressed onto one side or both sides of the backup substrate 18. That is, a pre-laminate 20 formed by laminating the sheet-form powder 14 on the backup substrate 18 is obtained. At this time, the sheet-form powder 14 is uniformly spread on the backup substrate 18 without fluidization/aggregation of the powder 12.

In this context, the smaller the roll diameter of the pre-molding roll 6 (rolls 6A, 6B) becomes, the smaller the bitten amount of the powder 12 can be made, and the smaller the finally obtained thickness (film thickness) of the sheet-form molded product 16 can be made. On the other hand, when the roll diameter of the pre-molding roll 6 (rolls 6A, 6B) is excessively small, distortion or the like occurs in the roll at the time of compressing the powder 12, thereby to cause the uneven thickness of the sheet-form powder 14.

Further, a point where a peripheral speed of the roll in the vicinity of a roll nip point (point of the minimum gap between a pair of rolls) and a moving speed of the powder become the same is referred to as a point P. When a region from the point p where a basis weight is decided to an outlet of the powder 12 (lower part of the rolls 6A and 6B of the pre-molding rolls 6) is not filled with the powder 12, a patchy pattern or a streak is generated at the time of molding the sheet-form powder 14 due to fluidization/aggregation of the powder. In this context, when the rotating speed of the roll is fixed, the smaller the roll diameter becomes, the lower the point P becomes. Accordingly, by making the roll diameter smaller, it is possible to make a volume from the point P to the outlet of the powder 12 smaller and suppress fluidization/aggregation of the powder at the time of molding the sheet-form powder 14, so that the sheet-form molded product 16 can have a small film thickness.

Taking these respects into consideration, the roll diameter of the pre-molding roll 6 (rolls 6A, 6B) is usually from 10 to 500 mm, preferably from 10 to 250 mm, and more preferably from 10 to 150 mm.

It is to be noted that by making the roll diameter of the pre-molding roll 6 (rolls 6A, 6B) small, pressure that is applied to the powder 12 becomes smaller. Therefore, although it is not possible to sufficiently increase the density of the sheet-form powder 14, it is possible to obtain the sheet-form molded product 16 whose density has been increased by compression by use of the molding rolls 8 as described later.

Next, the molding rolls 8 compress the pre-laminate 20 while applying pressure thereto. It is thereby possible to obtain a laminate 22 formed by laminating on the backup substrate 18 the sheet-form molded product 16 which was formed by further compressing the sheet-form powder 14. That is, the sheet-form powder 14 has a higher density than that of the powder 12, and the sheet-form molded product 16 has a higher density than that of the sheet-form powder 14.

The roll diameter of the molding roll 8 (rolls 8A, 8B) can be decided in accordance with pressure that is applied at the time of compressing the sheet-form powder 14, but it is usually from 50 to 1,000 mm, and preferably from 100 to 500 am.

As thus described, in the powder molding device according to the present embodiment, the pressure that is applied to the sheet-form powder 14 by the molding rolls 8 needs to be larger than the pressure that is applied to the powder 12 by the pre-molding rolls 6. Hence the molding rolls 8 (rolls 8A, 8B) are made up of the rolls each having a larger roll diameter than the roll diameter of the pre-molding roll 6 (rolls 6A, 6B).

Here, as for the backup substrate 18, a substrate in the form of a thin film may be used, and its thickness is usually from 1 to 1,000 μm, and preferably from 5 to 800 μm. Examples of the backup substrate 18 may include metal foil of aluminum, copper, stainless, iron and the like, paper, natural fiber, polymer fiber, fabric and a polymer resin film, and one can be selected as appropriate in accordance with a purpose. Examples of the polymer resin film may include polyester resin films of polyethylene-terephthalate, polyethylenenaphthalate and the like, or plastic films, sheets and the like containing polyimide, polypropylene, polyphenylene sulfide, polyvinyl chloride, aramid film, PEN, PEEK and the like.

Further, the surface of the backup substrate 18 may be subjected to processing such as coating, punching, buffing, sand-blasting and/or etching. A substrate obtained by applying an adhesive or the like to the surface of the backup substrate is particularly preferable since this substrate can strongly hold the sheet-form powder.

Examples of the powder stored in the space formed by the pre-molding rolls 6 and the partition plate 10 may include a composite particle containing an electrode active material. The composite particle contains the electrode active material and a binder, and may contain a dispersing agent, a conductive material and an additive as necessity.

In the case of using the composite particle as an electrode material for a lithium-ion secondary battery, the sheet-form molded product 16 can be used as an electrode layer, and in the case of using for a positive electrode, examples of a positive electrode active material may include a metal oxide capable of reversibly doping/de-doping lithium ions. Examples of such a metal oxide may include lithium cobaltate, lithium nickelate, lithium manganate, lithium iron phosphate, lithium manganese phosphate, lithium vanadium phosphate, lithium iron vanadate, lithium-nickel-manganese-cobaltate, lithium-nickel-cobaltate, lithium-nickel-manganate, lithium-iron-manganate, lithium-iron-manganese-cobaltate, lithium iron silicate, lithium manganese-iron silicate, vanacium oxide, copper vanadate, niobium oxide, titanium sulfide, molybdenum oxide and molybdenum sulphide. It is to be noted that the above exemplified positive electrode active materials may be used singly or used by mixing a plurality of kinds of materials as appropriate in accordance with applications.

The examples may further include polymers such as polyacetylene, poly-p-phenylene and polyquinone. Among these, the lithium-containing metal oxide is preferably used.

It is to be noted that examples of a negative electrode active material when used for a negative electrode as a counter electrode to the positive electrode for the lithium-ion secondary battery may include low crystalline carbon (amorphous carbon) such as easily graphitizable carbon, hardly graphitizable carbon, activated carbon and pyrolytic carbon, graphite (natural graphite, artificial graphite), carbon nano wall, carbon nano tube, and a composite carbon material of these carbons with different physical properties, an alloy materials of tin, silicon and the like, oxides such as silicon oxide, tin oxide, vanadium oxide and lithium titanate, and polyacene. It is to be noted that the above exemplified negative electrode active materials may be used singly or used by mixing a plurality of kinds of materials as appropriate in accordance with applications.

The electrode active material for the lithium-ion secondary battery preferably has a shape formed into a particulate shape. When the particle shape is spherical, it is possible to form an electrode with a higher density than the density at the time of molding the electrode.

A volume average particle diameter of the electrode active material for the lithium-ion secondary battery is usually from 0.1 to 100 μm, preferably from 0.5 to 50 μm, and more preferably from 0.8 to 20 μm.

Although a tap density of the electrode active material for the lithium-ion secondary battery is not particularly restricted, one with a tap density of not lower than 2 g/cm³ is suitably used for the positive electrode and one with a tap density of not lower than 0.6 g/cm³ is suitably used in the negative electrode.

In the case of using the composite particle as an electrode material for a lithium-ion capacitor, examples of the positive electrode active material may include activated carbon capable of reversibly doping/de-doping an anion and/or a cation, a polyacene organic semiconductor (PAS), carbon nano tube, a carbon whisker, and graphite. The preferable electrode active materials are activated carbon and carbon nano tube.

It is to be noted that as a negative electrode active material as a counter electrode to the positive electrode for the lithium-ion capacitor, any of the materials exemplified as the negative electrode active material for the lithium-ion secondary battery can be used. A volume average particle diameter of the electrode active material used for the lithium-ion capacitor is usually from 0.1 to 100 μm, preferably from 0.5 to 50 μm, and more preferably from 0.8 to 20 μm.

In the case of using activated carbon as the electrode active material for the lithium-ion capacitor, a specific surface area of activated carbon is usually not smaller than 30 m²/g, preferably from 500 to 3,000 m²/g, and more preferably from 1,500 to 2,600 m²/g. Up to the specific surface area of about 2,000 m²/g, the larger the specific surface area becomes, a capacitance per unit weight of activated carbon tends to increase. However, when the specific surface area is larger than 2,000 m²/g, the capacitance does not increase much, and a density of the electrode mixture layer tends to decrease and a density of the capacitance tends to decrease. Further, a size of a pore in activated carbon preferably match a size of an electrolyte ion in terms of rapid charge/discharge characteristics which are features as the lithium-ion capacitor. Therefore, selecting the electrode active material as appropriate can give an electrode mixture layer having desirable capacitance density and input/output characteristics.

In the case of using the composite particle as an electrode material for an electric double-layered capacitor, as a positive electrode active material and a negative electrode active material, any of the materials exemplified as the positive electrode active material for the lithium-ion capacitor can be used.

The binder used for the composite particles is not particularly restricted so long as it can bind the electrode active materials to each other. A suitable binder is a dispersible binder having a property of being dispersed in a solvent. A polymer dispersed in a solvent can be used as the dispersible binder, and examples of such a polymer may include a silicon polymer, a fluorine-containing polymer, a conjugated diene polymer, an acrylate polymer, and a polymer compound of polyimide, polyamide and polyurethane, and particularly, the fluorine-containing polymer, the conjugated diene polymer and the acrylate polymer are preferable; and the conjugated diene polymer and the acrylate polymer are more preferable.

The diene polymer is a copolymer obtained by polymerizing a homopolymer of conjugated diene or a monomer mixture containing conjugated diene, or a hydrogenated product thereof. A ratio of conjugated diene in the monomer mixture is usually not less than 40 wt %, preferably not less than 50 wt %, and more preferably not less than 60 wt %. Specific examples of the diene polymer may include: conjugated diene homopolymers such as polybutadiene and polyisoprene; an aromatic vinyl-conjugated diene copolymer such as a styrene-butadiene copolymer (SBR) which may be carboxy-modified; a vinyl cyanide-conjugated diene copolymer such as an acrylonitrile-butadiene copolymer (NBR); and hydrogenated SBR and hydrogenated NBR.

The acrylate polymer is a polymer containing a monomeric unit derived from a compound represented by General Formula (1): CH₂═CR¹—COOR² (where R¹ represents a hydrogen atom or a methyl group and R² represents an alkyl group or a cycloalkyl group), and is specifically a copolymer obtained by polymerizing a homopolymer of the compound represented by General Formula (1) or a monomer mixture containing the compound represented by General Formula (1). Specific examples of the compound represented by General Formula (1) may include: (meth)acrylic acid alkyl esters such as methyl (meth)acrylate, ethyl (meth)acrylate, propyl (meth)acrylate, isopropyl (meth)acrylate, n-butyl (meth)acrylate, isobutyl (meth)acrylate, cyclohexyl (meth)acrylate, 2-ethylhexyl (meth)acrylate, isopentyl (meth)acrylate, isooctyl (meth)acrylate, isobonyl (meth)acrylate, isodecyl (meth)acrylate, lauryl (meth)acrylate, stearyl (meth)acrylate, and tridecyl (meth)acrylate; ether group-containing (meth)acrylic esters such as butoxyethyl (meth)acrylate, ethoxydiethylene glycol (meth)acrylate, methyoxydipropylene glycol (meth)acrylate, methyoxypolyethylene glycol (meth)acrylate, phenoxyethyl (meth)acrylate, and tetrahydrofurfuryl (meth)acrylate; hydroxyl group-containing (meth)acrylic esters such as 2-hydroxyethyl (meth)acrylate, 2-hydroxypropyl (meth)acrylate, 2-hydroxy-3-phenoxypropyl (meth)acrylate, and 2-(meth)acryloyloxyethyl-2-hydroxyethyl phthalate; carboxylic acid-containing (meth)acrylic esters such as 2-(meth)acryloyloxyethyl phthalate, and 2-(meth) acryloyloxyethyl phthalate; a fluorine-containing (meth)acrylic ester such as perfluorooctyl ethyl (meth)acrylate; phosphate group-containing (meth)acrylic ester such as ethyl phosphite (meth)acrylate; an epoxy group-containing (meth)acrylic ester such as glycidyl (meth)acrylic acid ester; and an amino group-containing (meth)acrylic ester such as dimethylaminoethyl (meth)acrylic acid ester.

These (meth)acrylic acid esters can be used singly or in combination of two or more of kinds thereof. Among these, (meth)acrylic acid alkyl ester is preferable, and (meth)acrylic acid alkyl ester such as methyl (meth)acrylate, ethyl (meth)acrylate, n-butyl (meth)acrylate and (meth)acrylic acid alkyl ester with the number of carbon atoms being 6 to 12 in the alkyl group are more preferable. By selecting these, swelling with respect to the electrolyte can be reduced, and cycle characteristics can be improved.

A content rate of a (meth)acrylic acid ester unit in the dispersible binder is preferably from 50 to 95 wt %, and more preferably from 60 to 90 wt %. By setting the content rate of the (meth)acrylic acid ester unit in the above range, it is possible to improve the flexibility at the time of forming the electrode, and the durability against cracking can be high.

Further, the acrylate polymer may be a copolymer of the above-mentioned (meth)acrylic acid ester and a monomer copolymerizable with this ester, and examples of such a copolymerizable monomer may include an α, β-unsaturated nitrile monomer and a vinyl monomer having an acid component.

Examples of the α, β-unsaturated nitrile monomer may include acrylonitrile, methacrylonitrile, α-chloro acrylonitrile, and α-bromoacrylonitrile. These can be used singly or in combination of two or more of kinds thereof. Among these, acrylonitrile and methacrylonitrile are preferable, and acrylonitrile is more preferable.

A content rate of an α, β-unsaturated nitrile monomer unit in the dispersible binder is in the range of usually 0.1 to 40 wt %, preferably 0.5 to 30 wt %, and more preferably 1 to 20 parts by weight. By setting the content rate of the α, β-unsaturated nitrile monomer unit in the above range, it is possible to further enhance binding strength as the binder.

Examples of the vinyl monomer having an acid component may include acrylic acid, methacrylic acid, itaconic acid, maleic acid, and fumaric acid. These can be used singly or in combination of two or more of kinds thereof. Among these, acrylic acid, methacrylic acid and itaconic acid are preferable, methacrylic acid and itaconic acid are more preferable, and the combined use of methacrylic acid with itaconic acid is particularly preferable.

A content rate of a unit of the vinyl monomer having an acid component in the dispersible binder is preferably from 10 to 1.0 wt %, and more preferably from 1.5 to 5.0 wt %. By setting the content rate of the unit of the vinyl monomer having an acid component in the above range, it is possible to improve the stability in forming slurry.

Moreover, the acrylate polymer may be obtained by copolymerizing each of the foregoing monomers and another copolymerizable monomer, and examples of such another monomer may include carboxylate esters having two or more carbon-carbon double bonds, aromatic vinyl monomers, amide monomers, olefins, diene monomers, vinyl ketones, and heterocycle-containing vinyl compounds.

Although a shape of the dispersible binder is not particularly restricted, it is preferably particulate. By being particulate, the binder has good binding properties and can suppress reduction in capacitance of the produced electrode or degradation thereof due to repetition of charging/discharging. Examples of the particulate binder may include one in a state where particles of the binder like Latex are dispersed in water, and one in a powder form obtained by drying such a dispersed solution.

A volume average particle diameter of the dispersible binder is preferably from 0.001 to 100 μm, more preferably from 10 to 1,000 nm, and further preferably from 50 to 500 nm. By setting the average particle size of the dispersible binder particle in the above range, it is possible to make the stability favorable in forming slurry, while making the strength and flexibility as the obtained electrode favorable.

An amount of the binder is usually from 0.1 to 50 parts by weight, preferably from 0.5 to 20 parts by weight, and more preferably from 1 to 15 parts by weight with respect to 100 parts by weight of the electrode active material by dry weight. When the amount of the binder is in this range, the adhesion between the obtained electrode mixture layer and the current collector can be sufficiently ensured, and the internal resistance can be made low.

As described above, the dispersing agent may be used for the composite particles as necessary. Specific examples of the dispersing agent may include cellulosic polymers such as carboxymethylcellulose, methylcellulose, ethylcellulose and hydroxypropyl cellulose, ammonium salts and alkaline metal salts thereof, an alginic acid ester such as propylene glycol alginate, and an alginate such as sodium alginate, a polyacrylic acid, a polyacrylate (or methacrylate) such as sodium polyacrylate (or methacrylate), polyvinyl alcohol, modified polyvinyl alcohol, polyethylene oxide, polyvinyl-pyrrolidone, polycarboxylic acid, starch oxide, starch phosphate, casein, and a variety of modified starch, and chitin and chitosan derivatives. Further, a water-soluble polymer (specific group-containing water-soluble polymer) which contains one or more, preferably two or more groups such as a carbonyl group, a sulfonate group, a fluorine group, a hydroxyl group, and a phosphate group can be used as the dispersing agent.

These dispersing agents can be used singly or in combination of two or more of kinds thereof. Among them, the cellulosic polymers are preferable, and carboxymethyl cellulose or ammonium salt or alkaline metal salt thereof is particularly preferable. Further, the above specific group-containing water-soluble polymer is also preferable, and as the specific group-containing water-soluble polymer, an acrylic polymer having the above specific group and containing an acrylic acid ester monomer unit or a methacrylic acid ester monomer unit is particularly preferable.

Although a used amount of these dispersing agents is not particularly restricted so long as being in a range not impairing the effect of the present invention, it is in the range of usually 0.1 to 10 parts by weight, preferably 0.5 to 5 parts by weight, and more preferably 0.8 to 2 parts by weight with respect to 100 parts by weight of the electrode active material.

The composite particle is obtained by granulation by use of the electrode active material and the binder as well as other components such as the conductive material which are added as necessary, and at least contains the electrode active material and the binder, and each of the above components does not exist as an individually independent particle, but two or more components containing the electrode active material and the binder as the constitutional components form one particle. Specifically, a plurality of individual particles having the two or more components is bound to form a secondary particle, and a preferable particle is obtained such that a plurality of (preferably several to several tens of) electrode active materials is bound by the binder.

In the case of adding the conductive material to the composite particle, a content rate of the conductive material is preferably from 0.1 to 50 parts by weight, more preferably from 0.5 to 15 parts by weight, and further preferably from 1 to 10 parts by weight with respect to 100 parts by weight of the electrode active material. By setting the content rate of the conductive material in the above range, it is possible to sufficiently reduce internal resistance.

The shape of the composite particle is preferably spherical from the viewpoint of the fluidity. That is, when a minor axis diameter of the composite particle is Lₛ; a major axis diameter thereof is Lₗ; Lₐ=(Lₛ+Lₗ)/2; and spheroidicity (%) is a value obtained by (1−(Lₗ−Lₛ)/Lₐ)×100, the spheroidicity is preferably not less than 80%, and more preferably not less than 90%.

Here, the minor axis diameter Lₛ and the major axis diameter Lₗ are values measured by means of a scanning electron micrograph image.

A volume average particle diameter of the composite particle is in the range of usually 0.1 to 1,000 μm, preferably 1 to 200 μm, and more preferably 30 to 150 μm. This is preferable because, by setting the average particle size of the composite particle in this range, it is possible to easily obtain an electrode mixture layer with a desired thickness.

It is to be noted that an average particle size of the composite particle is a volume average particle diameter measured and calculated by a laser diffraction particle size analyzer (e.g., SALD-3100, manufactured by Shimadzu Corporation).

Although a structure as the composite particle is not particularly restricted, a preferable one is a structure where the binder is not unevenly distributed to the surface of the composite particle but uniformly distributed in the composite particle.

Although a method of producing the composite particles is not particularly restricted, the composite particle can be easily obtained by two production methods described in the following.

The first method of producing the composite particles is a fluidized bed granulation method. The fluidized bed granulation method has the steps of: obtaining slurry which contains the binder, as well as the conductive material, the dispersing agent and the other additives as necessary; and fluidizing the electrode active material in a heated air current and spraying the slurry thereto, to bind the electrode active materials to each other and dry them. Hereinafter, the fluidized bed particle method will be described.

(Fluidized Bed Granulation Method)

First, slurry is obtained which contains the binder, as well as the conductive material, the dispersing agent and the other additives as necessary. As a solvent used for obtaining the slurry, water is most suitably used, but an organic solvent can also be used. Specific examples of the organic solvent may include: alkyl alcohols such as methyl alcohol, ethyl alcohol and propyl alcohol; alkyl ketones such as acetone and methylethylketone; ethers such as tetrahydrofuran, dioxane and diglyme; and an amide such as diethylformamide, dimethyl acetamide, N-methyl-2-pyrrolidone (hereinafter, this may be referred to as NMP), and dimethyl imidazolidinone, but the alkyl alcohols are preferable. The combined use of an organic solvent having a lower boiling point than that of water can increase a drying speed at the time of fluidization granulation. Further, the combined use of the organic solvent having a lower boiling point than that of water leads to a change in dispersibility of the binder or the solubility of the soluble resin and allows preparation of the viscosity and the fluidity of the slurry by means of the amount or the kind of the solvent, thereby to allow improvement in productivity.

An amount of the solvent used at the time of preparing the slurry is an amount such that a concentration of a solid content of the slurry is in a range of usually 1 to 50 wt %, preferably 5 to 50 wt %, and more preferably 10 to 30 wt %. When the amount of solvent is in this range, the binder disperses uniformly, which is suitable.

A method or a procedure for dispersing or dissolving in the solvent the binder, as well as the conductive material, the dispersing agent and the other additives as necessary, is not particularly restricted, and examples thereof may include: a method of adding the binder, the conductive material, the dispersing agent and the other additives to the solvent to mix them; a method of dissolving the dispersing agent in the solvent, then adding thereto the binder (e.g., Latex) dispersed in the solvent to mix them, and finally adding the conductive material and the other additives to mix them; and a method of adding the conductive material to the dispersing agent dissolved in the solvent to mix them, and adding thereto the binder dispersed in the solvent to mix them. Examples of the means for mixing may include mixers such as a ball mill, a sand mill, a bead mill, a pigment disperser; a crusher, an ultrasonic disperser, a homogenizer and a planetary mixer. The mixing is usually performed in the range of room temperature to 80° C. for 10 minutes to several hours.

Next, the electrode active material is fluidized and the above slurry is sprayed thereto, to perform fluidization granulation. Examples of the fluidization granulation may include a method by a fluidized bed, a method by a modified fluidized bed, and a method by a spouted bed. The method by the fluidized bed is a method of fluidizing the electrode active material by a hot wind, and spraying the above slurry thereto from a spray or the like, to perform aggregation granulation. The method by the modified fluidized bed is similar to the above method by the fluidized bed, but it is a method of giving a circulation flow to the powder in the bed, and discharging granulated matters that have grown comparatively large by use of the classifying effect. Further, the method by the spouted bed is a method of making the slurry from a spray or the like adhere to coarse particles by use of the feature of a spouted bed to dry and granulate them simultaneously. As the method of producing the composite particles in the present invention, the method by the fluidized bed and the method by the modified fluidized bed are preferable among these three methods.

Although a temperature of the slurry to be sprayed is usually at room temperature, it may be increased by heating to the room temperature or higher. A temperature of the hot wind used for fluidization is usually from 70 to 300° C., and preferably from 80 to 200° C.

By the above method of producing, it is possible to obtain the composite particle that contains the electrode active material and the binder, as well as the conductive material, the dispersing agent and the other additives as necessary.

The second method of producing the composite particles is a spray-drying granulation method. According to the spray-drying granulation method, the composite particle of the present invention can be relatively easily obtained, which is preferable. Hereinafter, the spray-drying granulation method will be described.

(Spray-Drying Granulation Method)

First, slurry for the composite particles containing the electrode active material and the binder is prepared. The slurry for the composite particles can be prepared by dispersing or dissolving in the solvent the electrode active material and the binder, as well as the conductive material which is added as necessary. It is to be noted that in this case, when the binder is dispersed in water as a dispersion medium, it can be added in the state of being dispersed in water.

As the solvent used for obtaining the slurry for the composite particles, water is usually used, but a mixed solvent of water and an organic solvent may be used. Examples of the organic solvent usable in this case may include: alkyl alcohols such as methyl alcohol, ethyl alcohol and propyl alcohol; alkyl ketones such as acetone and methylethylketone; ethers such as tetrahydrofuran, dioxane and diglyme; and an amide such as diethylformamide, dimethyl acetamide, N-methyl-2-pyrrolidone, and dimethyl imidazolidinone. Among these, the alcohols are preferable. The combined use of water with an organic solvent having a lower boiling point than that of water can increase a drying speed at the time of spray-drying. Further, this allows adjustment of the viscosity and the fluidity of the slurry for the composite particles, thereby to allow improvement in productivity.

Moreover, at room temperature, the viscosity of the slurry for the composite particles is in the range of preferably 10 to 3,000 mPa·s, more preferably 30 to 1,500 mPa·s, and further preferably 50 to 1,000 mPa·s. When the viscosity of the slurry for the composite particles is in this range, it is possible to enhance the productivity in the spray-drying granulation step.

Further, in the present invention, the dispersing agent or a surfactant may be added as necessary at the time of preparing the slurry for the composite particles.

Although examples of the surfactant may include an anionic surfactant, a cationic surfactant, a nonionic surfactant, and an ampholytic surfactant such as a nonionic anionic surfactant, a preferable one is the anionic surfactant or the nonionic surfactant easy to thermally decompose. A blended amount of the surfactant is preferably not larger than 50 parts by weight, more preferably from 0.1 to 10 parts by weight, and further preferably from 0.5 to 5 parts by weight with respect to 100 parts by weight of the positive electrode active material.

A method or a procedure for dispersing or dissolving in the solvent the electrode active material and the binder, as well as the conductive material which is added as necessary, is not particularly restricted. As a mixer, for example, a ball mill, a sand mill, a bead mill, a pigment disperser, a crusher, an ultrasonic disperser, a homogenizer, a homomixer, a planetary mixer or the like can be used. The mixing is usually performed in the range of room temperature to 80° C. for 10 minutes to several hours.

Next, the obtained slurry for the composite particles is granulated by spray-drying. Spray-drying is a method of spraying the slurry into a hot wind to dry it. Examples of an apparatus used for spraying the slurry may include an atomizer. Two types of apparatuses, a rotary disk type and a pressurization type, can be cited as the atomizers, and the rotary disk type is a type in which the slurry is guided to the rough center of the rotating disk that rotates at a high speed, and the slurry is discharged to the outside of the disk by centrifugal force of the disk, to spray the slurry at that time. In the rotary disk type, a rotating speed of the disk depends on the size of the disk, but it is usually from 5,000 to 30,000 rpm, and preferably from 15,000 to 30,000 rpm. The lower the rotating speed of the disk is, the larger the sprayed droplet becomes, and the larger the average particle size of the obtained composite particle becomes.

Although examples of the rotary disk type atomizer may include a pin type and a vane type, the pin type atomizer is preferable. The pin type atomizer is a kind of centrifugal type spray apparatus using a spray disk, and is configured by the spray disk being detachably attached with a plurality of spray rollers between upper and lower fixed disks almost concentrically along their peripheries. The slurry for the composite particles is guided from the center of the spray disk, and adheres to the spray rollers by centrifugal force, moves outward on the surface of the roller, and finally leaves the roller surface to be sprayed. On the other hand, in the pressurization type, the slurry for the composite particles is pressurized and sprayed from a nozzle and dried

Although a temperature of the slurry for the composite particles to be sprayed is usually at room temperature, it may be increased by heating to higher than the room temperature. Further, a temperature of the hot wind at the time of spray-drying is usually from 80 to 250° C., and preferably from 100 to 200° C. In the spray-drying method, a method to blow a hot wind is not particularly restricted, and examples thereof may include: a method in which the hot wind and a spraying direction go in parallel in a transverse direction; a method in which spraying is carried out in a drying column top part, and the sprayed droplet falls with the hot wind; a method in which the sprayed droplet and the hot wind come into countercurrent-contact; and a method in which the sprayed droplet first goes in parallel with the hot wind, subsequently falls by gravity, and then comes into countercurrent-contact with the hot wind.

It is to be noted that as the spraying method, other than the method of spraying the slurry for the composite particles which has the electrode active material and the binder altogether, there can be used a method of spraying the slurry containing the binder, as well as the other additives as necessary, to the electrode active material being fluidized. From viewpoints of the easiness to control a particle size, the productivity, the possibility to make the particle size distribution small, and the like, the optimum method may be selected as appropriate in accordance with components of the composite particle, and the like.

The electrode mixture layer produced by the dry molding method is formed by containing the foregoing composite particles. The electrode mixture layer having target physical properties can be obtained by the composite particles alone or by containing the other binder or the other additives as necessary. A content of the composite particles in the electrode mixture layer is preferably not less than 50 wt %, more preferably not less than 70 wt %, and further preferably not less than 90 wt %.

As the other binder used as necessary, for example, a binder contained in the foregoing composite particles can be used. Since the composite particle has already contained the binder, it is not necessary to separately add the other binder in forming the electrode mixture layer, but the other binder may be added in order to enhance the binding strength of the composite particles. An added amount of the other binder in the case of adding the other binder is, in total with the binder in the composite particles, preferably from 0.01 to 10 parts by weight, and more preferably from 0.1 to 5 parts by weight with 100 parts by weight of the electrode active material. Further, examples of the other additives may include forming auxiliary agents such as water and alcohol, and such an amount of these as not to impair the effect of the present invention can be selected as appropriate and added.

According to the powder molding device in the foregoing embodiment, it is possible to produce a sheet-form molded product with a no-defect surface and a smaller film thickness. Further, since the sheet-form powder 14 is molded on the backup substrate 18 in the pre-molding step, the strength of the sheet-form powder 14 can be held until compression is performed in the regular compression step. That is, when the strength of the sheet-form powder 14 obtained by the powder passing through the pre-molding roll 6 is low, the sheet may collapse before reaching the molding roll 8 and a uniform sheet may not be obtained, but by simultaneously passing the powder 12 and the backup substrate 18 through the pre-molding roll 6, the sheet-form powder with low strength can be stably sent out to the molding roll 8.

It is to be noted that in the foregoing embodiment, in order to further reduce the unevenness of the thickness of the sheet-form molded product 16 and further increase the density of the sheet-form molded product 16 while reducing the film thickness thereof, pressurization may further be performed after the step of pressing the sheet-form molded product 16 by the rolls, or some other step.

Further, in the foregoing embodiment, the powder-molding device may be configured such that a guide role, a position detector, a thickness measuring machine and the like are provided between the pre-molding rolls 6 and the molding rolls 8.

Moreover, although the pre-molding rolls 6 are used in the pre-molding step in the foregoing embodiment, this is not limited thereto so long as the powder can be spread without fluidization/aggregation thereof in the pre-molding step, for example, a sheet-form powder having a density of 130 to 300% or the like of the density of the powder is molded.

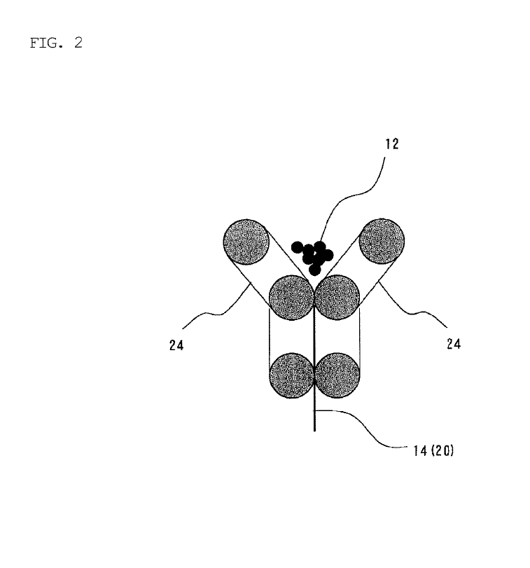

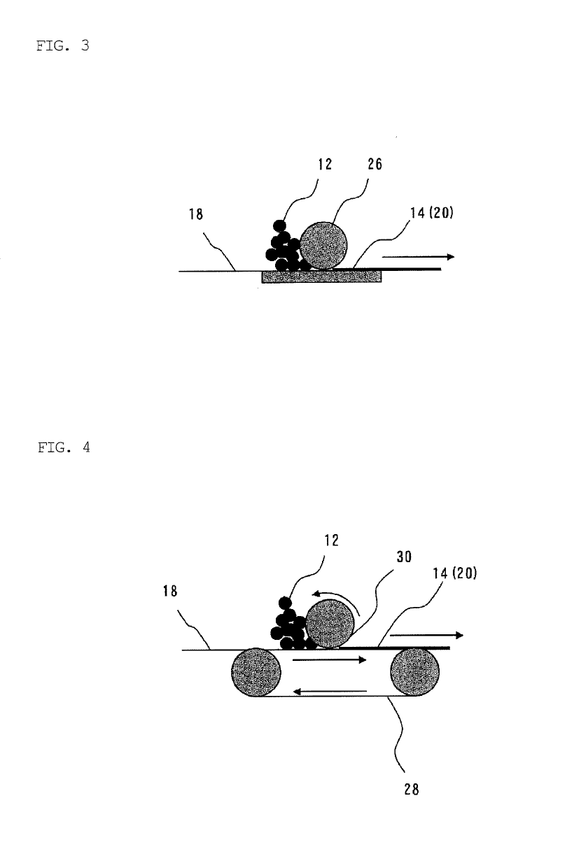

For example, the pre-molding rolls 6 may be replaced by compression belts 24 including a pair of belts shown in FIG. 2. Further, although the pre-molding rolls 6 include the pair of rolls in the foregoing embodiment, they may be replaced by a one-side roll 26 which include one roll arranged only on one side as shown in FIG. 3.

It is to be noted that an arrow of FIG. 3 shows a moving direction of the backup substrate 18, namely a direction in which the sheet-form powder 14 is formed.

Further, as shown in FIG. 4, a belt 28 may be arranged on one side and a roll 30 may be arranged on one side. It should be noted that arrows shown in the belt 28 of FIG. 4 show rotating directions of the belt 28, an arrow shown in the vicinity of the roll 30 shows a rotating direction of the roll 30, and an arrow above the sheet-form powder 14 (pre-laminate 20) shows a moving direction of the backup substrate 18, namely a direction in which the sheet-form powder 14 is formed. As thus described, in the case of forming the sheet-form powder 14 by the belt 28 and the roll 30, the roll 30 may be rotated in the opposite direction to the arrow shown in FIG. 4. Further, the roll 30 may not be rotationally driven as described above, but may be made freely rotatable as received force of movements of the belt 28 and the powder 12 and the like.

In the configurations shown in FIGS. 2 to 4, although the sheet-form powder 14 can be formed without using the backup substrate 18, the sheet-form powder 14 is preferably formed on the backup substrate 18.

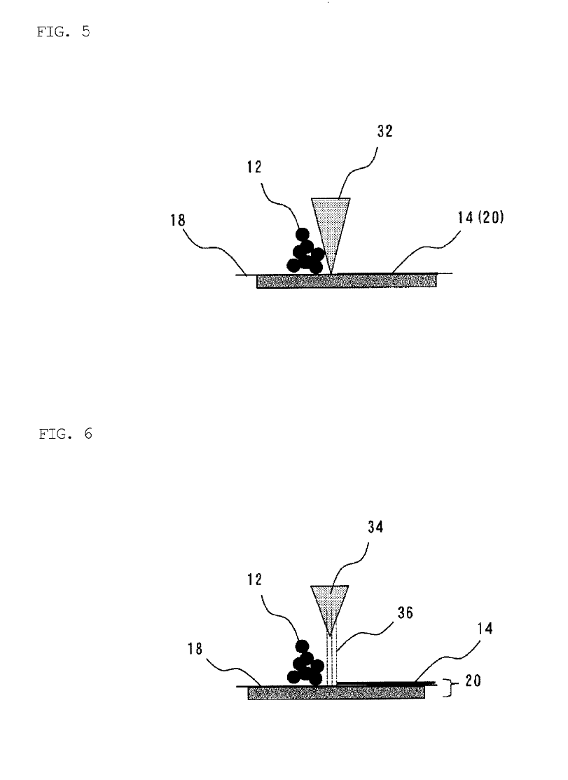

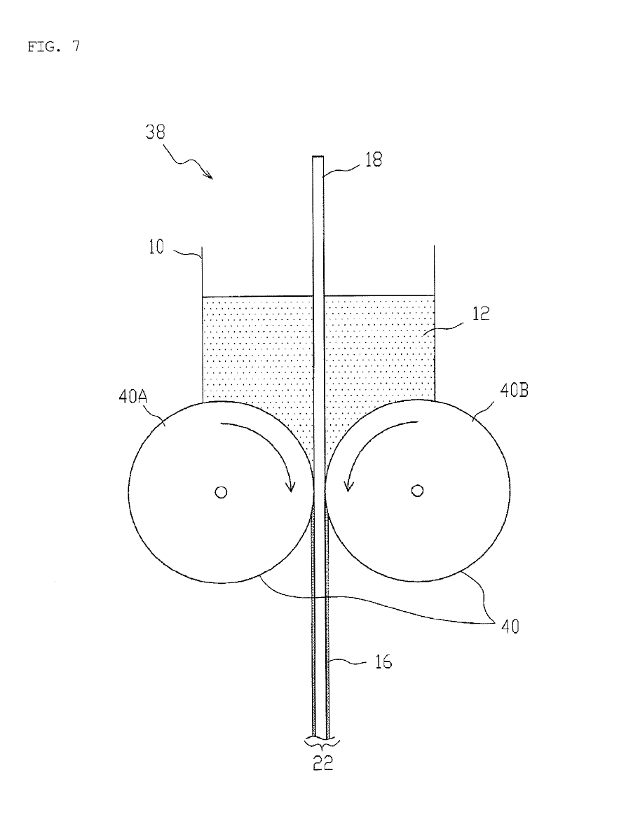

Moreover, the sheet-form powder 14 may be molded on the backup substrate 18 by using a doctor blade 32 as shown in FIG. 5, or an air doctor blade may be used as shown in FIG. 6. In the case of using the air doctor blade, the powder to be supplied to the backup substrate 18 by use of a doctor blade 34 is made even by an air 36, thereby to mold the sheet-form powder 14 on the backup substrate 18. Further, heat may be applied to the powder, thereby to mold the sheet-form powder 14 on the backup substrate 18.

Moreover, the powder may be electrified to be positive or negative at the time of molding the sheet-form powder 14 on the backup substrate 18. Although a method for electrifying the powder is not particularly restricted, examples thereof may include a method of directly applying a voltage to the powder to electrify it, and a method of electrifying the powder by friction. Examples of the method for directly applying a voltage to the electrode material to electrify it may include an electrification method using corona discharge. Examples of the electrification method using corona discharge may include a method of passing the powder through the vicinity of a corona discharge electrode in spraying the powder onto the current collector to electrify it, and a method of bringing the powder into a fluidized state (fluidized bed) and installing the corona discharge electrode therein to electrify it.

In the case of frictionally electrifying the powder, the powder can be electrified to be positive by being brought into contact with polytetrafluoroethylene, vinyl chloride or the like, and can be electrified to be negative by being brought into contact with nylon or the like.

### EXAMPLES

Hereinafter, the present invention will be more specifically described by showing Examples and Comparative Examples, but the present invention is not restricted to Examples below. Further, part and % are by weight unless stated otherwise.

### Example 1

### Production of Composite Particle Used for Formation of Electrode Layer

100 parts of electrode active material (activated carbon having a specific surface area of 2,000 m²/g and a weight average particle diameter of 5 μm), 5 parts of conductive material (acetylene black “Denka Black Powder”: manufactured by Denki Kagaku Kogyo K.K.), 7.5 parts of solid content of a dispersible binder (“AD211”: 40% aqueous dispersion of a cross-linked acrylate polymer with an average particle diameter of 0.15 μm and a glass transition temperature of −40° C.; manufactured by Zeon Corporation), 1.4 parts of solid content of a soluble resin (1.5% solution of carboxymethyl cellulose “DN-800-H”; manufactured by Daicel Chemical Industries, Ltd.), and 231.8 parts of ion exchanged water were stirred and mixed by a “TK homomixer” (manufactured by Tokushukika Co., Ltd.) to obtain slurry A having a solid content of 25%. Subsequently, the slurry A was spray-dried by a hot wind at 150° C. by use of a spray drier (with a pin type atomizer, manufactured by Ohkawara Kakohki Co., Ltd.), to obtain a composite particle A having a weight average particle diameter of 50 μm. A weight average particle diameter of this composite particle A was measured by use of a powder measurement apparatus (Powder Tester PT-S; manufactured by Hosokawa Micron Corp.).

### Molding of Sheet-Form Molded Product

### Example 1-1

In the powder molding device 2 having the device configuration shown in FIG. 1, a roll diameter of the pre-molding roll 6 (rolls 6A, 6B) was 50 mm, a roll gap of the pre-molding rolls 6 (rolls 6A, 6B) was 50 μm, a roll diameter of the molding roll 8 (rolls 8A, 8B) was 250 mm, a roll gap of the molding rolls (rolls 8A, 8B) was 50 μm, and a roll temperature was 100° C. Further, aluminum foil having a thickness of 30 μm with its surface as the backup substrate 18 treated by a conductive adhesive was used. The foregoing composite particle A and the aluminum foil were injected into the powder molding device 2, to obtain a laminate of the sheet-form molded product 16 of the composite particle and the aluminum foil.

A powder density of the composite particles A was 0.2 g/cm³, an average density of the sheet-form powder after passing through the pre-molding rolls 6 was 0.49 g/cm³, and an average thickness was 100 μm, and an average density of the sheet-form molded product after passing through the molding rolls 8 was 0.55 g/cm³, and an average thickness was 90 μm.

### Example 1-2

A sheet-form molded product was obtained in the same manner as in Example 1 except that the roll diameter of the pre-molding roll 6 was changed to 20 mm. An average density of the sheet-form powder after passing through the pre-molding rolls 6 was 0.48 g/cm³, and an average thickness was 91 μm, and an average density of the sheet-form molded product after passing through the molding rolls 8 was 0.55 g/cm³, and an average thickness was 80 μm

### Comparative Example 1-1

In a roll type pressure-molding device 38 having only a pair of rolls 40A, 40B as shown in FIG. 7, the sheet-form molded product was obtained in the same manner as in Example 1 except that a roll diameter of the molding roll 40 was 250 mm, a roll gap was 50 μm, and a roll temperature was 100° C. The unevenness of the thickness occurred in the sheet-form molded product obtained in Comparative Example 1-1, and the sheet was not uniformly formed. An average density of this sheet-form molded product was 0.54 g/cm³, and an average thickness thereof was 190 μm.

(Evaluation Method of Sheet-Form Molded Product)

The sheet-form molded products obtained in Examples 1-1, 1-2 and Comparative Example 1-1 were each punched out into a circular shape with a diameter of 16 mm, and a thickness and a weight thereof were measured, to calculate a density. When the backup substrate is laminated, a thickness and a weight of the backup substrate punched out into a 16-mm circular shape were excluded after the measurement, to calculate the density.

TABLE 1

| | | Example | Example | Comparative |
|---|---|---|---|---|
| | | 1-1 | 1-2 | Example 1-1 |
| First roll diameter (mm) | | 50 | 20 | 250 |
| Second roll diameter (mm) | | 250 | 250 | — |
| Evaluation | Average thickness | 90 | 80 | 190 |
| result | (μm) | | | |
| | Average density | 0.55 | 0.55 | 0.54 |
| | (g/cm³) | | | |
| | Sheet surface | None | None | Thickness |
| | defect | | | unevenness |
| | | | | occurred. |

From the result of Table 1, in Comparative Example 1 molded by the roll type pressure-molding device 38 having only the pair of rolls 40A, 40B, the thickness of the molded product was large, and the unevenness of the thickness occurred on the sheet surface. On the contrary, it is found that a thinner sheet can be produced when two pairs of rolls respectively having different roll diameters are used and a sheet-form molded product having a second density is molded after molding of a sheet-form powder having a first density.

### Example 2

Further, while the roll diameter of the pre-molding roll 6 (rolls 6A, 6B) was changed, the rotating speed of the pre-molding roll 6 was changed, to calculate the range of a moldable film thickness with respect to each roll diameter. It is to be noted that the range in which the sheet-form molded product becomes a sheet having a uniform thickness was shown as the range of the formable film thickness.

In the powder molding device 2 having the device configuration shown in FIG. 1, the sheet-form molded product was produced such that a roll diameter of the pre-molding roll 6 (rolls 6A, 6B) was a predetermined diameter, a gap of the pre-molding rolls 6 (rolls 6A, 6B) was 50 μm, a roll diameter of the molding roll 8 (rolls 8A, 8B) was 250 mm, a gap of the rolls molding roll 8 (rolls 8A, 8B) was 50 μm, and a roll temperature was 100° C. Here, the respective sheet-form molded products were produced such that the roll diameters of the pre-molding rolls 6 were 20 mm, 50 mm and 80 mm. Further, the rotating speed of the pre-molding roll 6 was changed with respect to each roll diameter. At the time of producing the sheet-form molded product, the foregoing composite particle A and the aluminum foil used in Example 1-1 were injected into the powder molding device 2, to measure an amount (basis weight, unit: mg/cm²) of the powder targeted onto the aluminum foil by the pre-molding roll 6.

From an actual film thickness of the above obtained sheet-form molded product and the above measured basis weight, the formable minimum film thickness and maximum film thickness were calculated with respect to each roll diameter in the case of molding the sheet-form molded product such that the density of the powder in the sheet-form molded product was 0.06 g/cc. Results are shown in Table 2. It is to be noted that with respect to any of the roll diameters, the more the rotating speed of the pre-molding roll 6 was increased, the smaller the film thickness of the formable sheet-form molded product became.

TABLE 2

| Pre-molding roll | Pre-molding roll | |
|---|---|---|
| diameter (mm) | rotating speed (rpm) | Film thickness (μm) |
| 20 | 239 | 100 (Maximum film |
| | | thickness) |
| 20 | 16 | 71.6 (Minimum film |
| | | thickness) |
| 50 | 127 | 168 (Maximum film |
| | | thickness) |
| 50 | 6.4 | 75 (Minimum film |
| | | thickness) |
| 80 | 74 | 333 (Maximum film |
| | | thickness) |
| 80 | 2.4 | 117 (Minimum film |
| | | thickness) |

It was indicated from the results shown in Table 2 that, when the roll diameter of the pre-molding roll 6 (rolls 6A, 6B) is smaller than the roll diameter of the molding roll 8 (rolls 8A, 8B), the minimum film thickness of the moldable sheet-form molded product 16 decreases depending on the size of the pre-molding roll 6 (rolls 6A, 6B).

### Example 3-1

In the powder molding device 2 having the device configuration shown in FIG. 1, the sheet-form molded product was produced such that a roll diameter of the pre-molding roll 6 (rolls 6A, 6B) was 50 mm, a gap of the pre-molding rolls 6 (rolls 6A, 6B) was 150 μm, a roll diameter of the molding roll 8 (rolls 8A, 8B) was 250 mm, a gap of the rolls molding roll 8 (rolls 8A, 8B) was 150 and a roll temperature was 100° C., and the accuracy in film thickness in a width direction was measured, whose result was shown in Table 3. In Table 3, R shows a difference between the maximum value and the minimum value of the film thickness, and a shows a standard deviation representing the unevenness of the film thickness. Further, as a variation coefficient, one obtained by dividing the standard deviation σ by an average film thickness in the width direction is shown.

It should be noted that at the time of producing the sheet-form molded product, the foregoing composite particle A and the aluminum foil used in Example 1-1 were injected into the powder molding device 2.

### Comparative Example 3-1

In the roll type pressure-molding device 38 having only a pair of rolls 40A, 40B as shown in FIG. 7, the sheet-form molded product was obtained in the same manner as in Example 3-1 except that a roll diameter of the molding roll 40 was 250 mm and a roll gap was 150 μm, and the accuracy in film thickness in a width direction was measured, whose result was shown in Table 3.

TABLE 3

| | | | Variation |
|---|---|---|---|
| | R | σ | coefficient |
| Example 3-1 | 24 μm | 9.28 | 3.19 % |
| Comparative | 89 μm | 28.3 | 7.89 % |
| Example 3-1 | | | |

It was indicated from the results shown in Table 3 that, when the pre-molding rolls 6 (rolls 6A, 6B) are used and the roll diameter of the pre-molding roll 6 is smaller than the roll diameter of the molding roll 8 (rolls 8A, 8B), it is possible to obtain a sheet-form molded product with small unevenness of the thickness, namely having a uniform thickness.

In addition, a similar result to those of foregoing Examples 2 and 3 could be obtained also in the case of using particles for a lithium battery negative electrode as the composite particles. In this case, 100 parts of electrode active material (activated carbon having a specific surface area of 7 m²/g and a weight average particle diameter of 11.5 μm), 0.7 parts of solid content of a soluble resin (1% solution of carboxymethyl cellulose “CMC BSH-12”: manufactured by DAI-ICHI KOGYO SEIYAKU CO., LTD.), 4 parts of binder (SBR polymer), and 119 parts of ion exchanged water were stirred and mixed by a “TK homomixer” (manufactured by Tokushukika Co., Ltd.) to obtain slurry B having a solid content of 35%. Subsequently, slurry C was spray-dried by a hot wind at 150° C. by use of a spray drier (with a pin type atomizer, manufactured by Ohkawara Kakohki Co., Ltd.), to obtain a composite particle B having a particle diameter of 40 to 60 μm, and the sheet-form molded product was produced in the same manner as in the foregoing Examples 2 and 3.

### EXPLANATION OF REFERENCE NUMERALS

2 . . . powder molding device
6 . . . pre-molding roll
8 . . . molding roll
12 . . . powder
14 . . . sheet-form powder
16 . . . sheet-form molded product
18 . . . backup substrate

1. A powder molding device, comprising:
a pre-molding unit for molding a sheet-form powder having a first density higher than a density of the powder and not having fluidity by compressing a powder; and
a molding roll for molding a sheet-form molded product having a second density higher than the first density by compressing the sheet-form powder.

2. The powder molding device according to claim 1, wherein the first density is not lower than 130% and not higher than 300% of the density of the powder.

3. The powder molding device according to claim 1, wherein the pre-molding unit is provided with a pre-molding roll having a smaller diameter than a diameter of the molding roll.

4. The powder molding device according to claim 3, wherein the diameter of the pre-molding roll is not smaller than 10 mm and not larger than 500 mm.

5. The powder molding device according to claim 1, wherein
the pre-molding unit molds a pre-laminate including the sheet-form powder and the backup substrate by compressing the powder onto a backup substrate, and
the molding roll molds a laminate including the sheet-form molded product and the backup substrate by compressing the pre-laminate.

6. A method of producing a powder molded product, comprising:
a pre-molding step of obtaining a sheet-form powder having a first density higher than a density of the powder and not having fluidity by compressing a powder; and
a regular compression step of obtaining a sheet-form molded product having a second density higher than the first density by compressing the sheet-form powder using a pair of molding rolls.

7. The method of producing a powder molded product according to claim 6, wherein the first density is not lower than 130% and not higher than 300% of the density of the powder.

8. The method of producing a powder molded product according to claim 6, wherein in the pre-molding step, the powder is compressed by use of a pre-molding roll having a smaller diameter than a diameter of the molding roll.

9. The method of producing a powder molded product according to claim 8, wherein the diameter of the pre-molding roll is not smaller than 10 mm and not larger than 500 mm.

10. The method of producing a powder molded product according to claim 6, wherein
in the pre-molding step, the powder is compressed onto a backup substrate to mold a pre-laminate including the sheet-form powder and the backup substrate, and
in the regular compression step, the pre-laminate is compressed by use of the molding rolls to mold a laminate including the sheet-form molded product and the backup substrate.

11. The powder molding device according to claim 2, wherein the pre-molding unit is provided with a pre-molding roll having a smaller diameter than a diameter of the molding roll.

12. The powder molding device according to claim 11, wherein the diameter of the pre-molding roll is not smaller than 10 mm and not larger than 500 mm.

13. The powder molding device according to claim 2, wherein
the pre-molding unit molds a pre-laminate including the sheet-form powder and the backup substrate by compressing the powder onto a backup substrate, and
the molding roll molds a laminate including the sheet-form molded product and the backup substrate by compressing the pre-laminate.

14. The powder molding device according to claim 3, wherein
the pre-molding unit molds a pre-laminate including the sheet-form powder and the backup substrate by compressing the powder onto a backup substrate, and
the molding roll molds a laminate including the sheet-form molded product and the backup substrate by compressing the pre-laminate.

15. The powder molding device according to claim 4, wherein
the pre-molding unit molds a pre-laminate including the sheet-form powder and the backup substrate by compressing the powder onto a backup substrate, and
the molding roll molds a laminate including the sheet-form molded product and the backup substrate by compressing the pre-laminate.

16. The powder molding device according to claim 12, wherein
the pre-molding unit molds a pre-laminate including the sheet-form powder and the backup substrate by compressing the powder onto a backup substrate, and
the molding roll molds a laminate including the sheet-form molded product and the backup substrate by compressing the pre-laminate.

17. The method of producing a powder molded product according to claim 7, wherein in the pre-molding step, the powder is compressed by use of a pre-molding roll having a smaller diameter than a diameter of the molding roll.

18. The method of producing a powder molded product according to claim 17, wherein the diameter of the pre-molding roll is not smaller than 10 mm and not larger than 500 mm.

19. The method of producing a powder molded product according to claim 7, wherein
in the pre-molding step, the powder is compressed onto a backup substrate to mold a pre-laminate including the sheet-form powder and the backup substrate, and
in the regular compression step, the pre-laminate is compressed by use of the molding rolls to mold a laminate including the sheet-form molded product and the backup substrate.

20. The method of producing a powder molded product according to claim 8, wherein
in the pre-molding step, the powder is compressed onto a backup substrate to mold a pre-laminate including the sheet-form powder and the backup substrate, and
in the regular compression step, the pre-laminate is compressed by use of the molding rolls to mold a laminate including the sheet-form molded product and the backup substrate.
